(19) United States
(12) Patent Application Publication
(10) Pub. No.: US 2014/0091574 A1
(43) Pub. Date: Apr. 3, 2014

(54) DEVICE FOR STORING AND DELIVERING FLUIDS AND METHOD FOR STORING AND DELIVERING A COMPRESSED GAS CONTAINED IN SUCH A DEVICE

(71) Applicant: STOREWATT, Fucon de Barcelonnette (FR)

(72) Inventor: Claude Favy, Faucon de Barcelonnette (FR)

(73) Assignee: STOREWATT, Faucon de Barcelonnette (FR)

(21) Appl. No.: 14/118,949

(22) PCT Filed: May 22, 2012
(86) PCT No.: PCT/FR2012/051154

§ 371 Date: Nov. 20, 2013

(30) Foreign Application Priority Data
May 23, 2011 (FR) 11 01589

(51) Int. Cl. F15B 15/02; F01D 15/10

(52) U.S. Cl. CPC F15B 15/02; F01D 15/10
USPC 290/52; 137/209; 60/327

(57) ABSTRACT

A device for storing and delivering fluids, the fluids including a gas and a liquid, the device including: at least one container (1) for storing the fluids, a gas inlet (2) and a gas outlet, an inlet and an outlet for the liquid, at least one facility (8) for injecting gas into the container (1) for storing the fluids; at least one outlet facility (9) connected to the gas outlet for evacuating the compressed gas, liquid discharging elements, and at least one motor group (15) including at least one pump (17) and at least one motor (18) for injecting the pressurized liquid into the container (1) for storing the fluids via the liquid inlet.

The invention concerns a device for storing and delivering a compressed gas, and in particular for storing and delivering electrical energy by means of a gas that is compressed then expanded.

The invention also includes a device for extracting and storing the heat produced by compressing the gas and restoring this heat to the gas prior to or during its expansion.

The use of compressed gas, especially compressed air, is a major cost item for most industries today. Although this is not an exhaustive list, these include the aeronautics, aerospace, agribusiness, automotive, chemical, metallurgy, glassware, petroleum, and glass industries. The production of compressed air alone consumes 10% of the electricity used in industry.

Providing a high storage capacity for these gases at the pressures commonly used in industry, which range from six bars to tens of bars, is seldom employed because of the low density of the gas in storage and the variable pressures at delivery.

This means the gas must be compressed simultaneously with its use in processes, generating significant additional costs, for example due to the electricity consumption during the most expensive hours or the large dimensions of the compression units.

The storage of electrical energy, which is one of the applications for compressed gas, is assuming crucial importance in being able to contribute to the stability of the electrical grid, meet demand during peak periods, participate in the integration of intermittent energy sources such as wind and solar, allow the storage of inexpensive or clean energy during periods of low demand which is when electricity is cheapest for delivery during periods of high demand which is when it is the most expensive, and supplement non-reactive production means during peak periods, to name a few applications.

Many techniques have been developed involving storage on a large scale, the most common being pumped hydropower storage and compressed air energy storage where electrical energy is used to compress air that is stored in compressed form in artificial or natural reservoirs. The expansion of this air through turboexpanders delivers a portion of the electrical energy used for the compression.

Various thermodynamic cycles are used in this technique. The simplest is to compress air using motor-driven compressors, allowing multi-staged compression with intercooling periods in order to approach isothermal compression and expend as little energy as possible during the air compression. The compressed air is then stored in a reservoir. Today's high capacity reservoirs are natural or artificial underground cavities. When the electrical power is to be delivered, the compressed air is extracted from the reservoir, warmed by adding external thermal energy, for example using fuel oil, natural gas, electricity, or any other heat source, and is expanded through a turbine which drives an electric generator. This cycle has a fairly low energy efficiency, especially considering the need to provide external thermal energy to warm the air before it passes through the turbine, as the heat generated during the air compression was lost to the cycle.

Numerous other thermodynamic cycles have been proposed with heat recovery at the turbine output to improve the general efficiency of the cycle.

One of the cycles, called the “adiabatic” cycle, uses polytropic compressors to extract heat from the compressed air at each stage of the compression and to store this heat, the compressed air being stored in a reservoir. When the electrical energy is to be delivered, the compressed air is extracted from the reservoir, heated by the heat stored during its compression, and expanded through a turbine which drives an electric generator. This “adiabatic” cycle avoids the use of additional external heat and provides efficiencies greater than 70% due to the recovery of the heat generated during compression. It emits no CO2.

Currently, large-capacity gas storage facilities use natural or artificial underground cavities or manufactured rigid tanks to store the compressed air.

Underground cavities require a specific geological context in terms of fluid-tightness, of pressure the surrounding rock can tolerate, and of seismic risk. The possibilities for usable locations are limited and do not necessarily correspond to desirable areas for storing electrical energy, for example because of their remoteness from where the energy will be consumed or produced, or an insufficient electrical grid in these areas.

One of the major drawbacks of such facilities is that they do not allow maintaining a constant pressure during the air storage and delivery.

This then requires either: a compression facility that can operate with a variable output pressure, an expansion facility that can operate with a variable input pressure, and a use of air storage within a pressure range corresponding to the operating pressure range of the compression and expansion facilities; or regulating the output pressure from the storage to the minimum value of the operating range for the storage. These pressure variations greatly influence the efficiency of the plant as well as its service capacity for storing compressed air. For example, the facility in Huntorf, Germany uses underground storage of 310,000 m3 within a pressure range of 43 to 70 bar. The Macintosh facility in the U.S. uses underground storage of 370,000 m3 with a pressure range of 45 to 80 bar. One will note that the maximum pressures, given the stability constraints of underground cavities, are limited to 80 bar and the usable pressure range is about 40 bar. These two factors severely limit the energy that can be stored per unit volume of the reservoir.

A concept proposed in U.S. Pat. No. 4,355,923 concerning storage in an underground cavern, is to obtain a constant pressure by linking the cavern with a hydraulic reservoir located at a higher altitude. This concept requires having very special geological conditions and limiting the pressure in the reservoir to the hydrostatic pressure generated by the hydraulic reservoir.

More recently, two concepts have been proposed for storing gas underwater, one using a flexible underwater reservoir, as in U.S. Pat. No. 6,863,474 B2, and the other to a rigid underwater reservoir, as in U.S. Pat. No. 7,735,506 B2, for maintaining the gas pressure at the hydrostatic pressure prevailing at the depth where the storage is installed. The ability to maintain a constant pressure during gas storage and delivery is a major advantage of these concepts. However, as these are underwater facilities installed at great depths, they are complex and expensive to implement and operate.

Both concepts also have the disadvantage of only being able to operate at a pressure equal to the hydrostatic pressure prevailing at the depth where the storage is located.

However, it is apparent that for a given type of reservoir, it is economically advantageous to store the gas at the maximum pressure compatible with both the mechanical stresses on the reservoir components and the maximum thicknesses that are technically possible. The ability to choose the pressure inside the storage independently of the external environment is therefore highly attractive.

Finally, “adiabatic” cycles which associate good potential yields with conventional turbocompressors and turboexpanders require storing large amounts of heat. Storage of sensible heat, meaning with no change of state, either calls for solids such as rock, concrete, sand, graphite, or ceramics, with the difficulty of sizing satisfactory exchangers, or liquids such as oils or salts, most of which pose certain risks to the environment and present storage difficulties. Storage of latent heat is still rarely used despite its significant potential, i.e. with state change. Water, with its high sensible heat, good thermal conductivity, possibility for use as a heat transfer medium and heat storage medium, low cost, and lastly the fact that it poses no hazard to the environment, is a excellent candidate aside from the high storage pressure required for high temperatures.

The device according to the invention provides an answer to these challenges, specifically:
it can store and deliver a gas in a rigid container, at very high and nearly constant pressure due to a liquid, it being possible to select the pressure independently of the pressure conditions in the environment around the storage, including the hydrostatic pressure in the case of underwater storage;
it allows recovering a very major portion of the energy spent to maintain this gas at a nearly constant pressure during the gas delivery operation;
it allows recovering a major portion of the compression energy expended to compress the gas to a storage pressure much higher than the pressure at which it is used in an industrial process, as well as the energy produced during the gas expansion;
the storage part of the device can be installed on land, without requiring a particular geological or topographical environment, or underwater, which then allows the facility to benefit from the hydrostatic pressure prevailing at the storage both in terms of the container resistance and the reduced pump and turbine pressures;
it can take advantage of existing hydraulic reservoirs;
it provides an amount of stored electrical energy per m3 of storage that is far superior to existing facilities,
it can respond quickly to a high demand for energy;

Moreover:
the device makes it possible to ensure fluidtightness between the gas and the liquid in order to maintain the gas at a substantially constant pressure;
it advantageously allows installing the storage portion in either a vertical or a horizontal position and even in an inclined position;
it limits the effect of possible leaks from the storage portion which could result from failures in the fluidtightness of the gas/liquid separation system.

Plus:
the device allows storing heat in an adiabatic operation;
it allows using water as the heat transfer fluid for storing heat during an “adiabiatic” cycle;
it can avoid the use of a fluid that poses an environmental risk.

In addition:
the device can be used for inexpensive storage of gas to be used industrially at a pressure lower than the storage pressure,
the device allows a combined use of energy storage and delivery,
the device can advantageously be installed directly at an industrial site in order to benefit from the site facilities and also to supply the site facilities.

A first aspect of the invention therefore relates to a device for storing and delivering fluids, said fluids comprising a gas and a liquid, said device comprising:
at least one fluid storage container comprising a gas containing portion and a liquid containing portion,
an inlet port connected to a gas source and an outlet port for the gas, opening into the gas containing portion of the fluid storage container,
a liquid inlet port and outlet port, opening into the liquid containing portion of the container,
at least one compression facility connected to a gas source and to the gas inlet port, for injecting compressed gas at an input pressure into the fluid storage container;
at least one discharge facility connected to the gas outlet port, for discharging the compressed gas,
means for discharging the liquid,
at least one motor group, connected to a source of liquid and to the liquid inlet port, the motor group comprising at least one pump and at least one motor for injecting the pressurized liquid into the fluid storage container through the liquid inlet port.

The device thus offers many possibilities for using, storing, and delivering a gas at a predetermined pressure, and has numerous applications in the fields of energy and of industrial processes that use a compressed gas.

The storage and delivery of the gas is reliable and is done more cheaply.

Preferably, the device comprises separation means between the gas and the liquid in the fluid storage container, to prevent the gas and the liquid from mixing.

According to one embodiment, the separation means comprise a flexible membrane that can deform under the pressure in the fluid storage container, to accommodate the variations in volume of the liquid containing portion and the gas containing portion.

A second aspect of the invention proposes that the separation means between the gas and the liquid comprise a rigid, movable diaphragm defining a separation surface between the liquid and the gas in the fluid storage container, and comprising bearing surfaces pressing against the fluid storage container, the bearing surfaces being offset to each side of the separation surface.

Such an arrangement can be implemented in any fluid storage container containing multiple fluids.

The offset bearing surfaces of the separation surface prevent the rigid diaphragm from tilting under the effect of a non-uniform pressure distribution on the diaphragm, which could cause leakage between the liquid containing portion and the gas containing portion.

Preferably, the diaphragm is peripherally equipped with seals to ensure fluidtightness between the gas containing portion and the liquid containing portion.

In addition, the bearing surfaces of the diaphragm can be equipped with roller mechanisms to facilitate the movement of the diaphragm within the fluid storage container and to accommodate variations in the volume of the liquid containing portion and the gas containing portion.

The bearing surfaces may be continuous along the circumference of the diaphragm, may be discontinuous along the circumference of the diaphragm, or may present a unit area of contact with the container that differs according to the bearing surface.

It is particularly advantageous if the liquid containing portion is connected to the gas containing portion, on the one hand by a first pipe equipped with a pump which allows bringing liquid in the gas containing portion to the liquid containing portion, and on the other hand by a second pipe equipped with a compressor which allows bringing gas in the liquid containing portion to the gas containing portion.

This arrangement is particularly advantageous when the container is placed on the ground and is at an angle relative to the horizontal. In this manner, regardless of the type of fluid storage container, if a diaphragm failure causes liquid to leak towards the gas containing portion and conversely causes gas to leak towards the liquid containing portion, such leakages are recovered.

A third aspect of the invention proposes the installation of a system for exchanging heat between the gas and a heat transfer fluid, during the compression of the gas in the compression facility and during the expansion of the gas in the expansion facility, in order to obtain an adiabatic gas compression and expansion cycle.

Specifically, the heat exchange system comprises a heat reservoir for storing the heat transfer fluid heated by the gas compression, said heat reservoir being thermally insulated and comprising means for pressurizing the heat transfer fluid.

According to a first embodiment, the heat reservoir is located inside the gas containing portion of the fluid storage container, and comprises a plunger interfacing with the gas in the fluid storage container and the heat transfer fluid in the heat reservoir.

Thus, the heat transfer fluid is kept pressurized to prevent it from vaporizing, without using additional means but instead using the pressure of the compressed gas, which reduces the size and cost of the device.

According to a second embodiment, the heat reservoir is located outside the fluid storage container and comprises a portion supplied with heat transfer fluid and a portion supplied with compressed gas, the two portions being located on each side of a diaphragm arranged in the heat reservoir to ensure fluidtightness between the two portions.

In addition to the advantages mentioned above for the first embodiment, the second embodiment does not reduce the gas storage volume in the fluid storage container.

Preferably, the heat transfer fluid is water, which in addition to being inexpensive and widely available, is without environmental risk as a pollutant.

These embodiments of the heat exchange system may be implemented in combination with any gas storage container. They allow the use of water as a heat transfer fluid while keeping the water pressurized and preventing it from vaporization.

The device may further include the following arrangements, alone or in combination:
the liquid inlet port is combined with the liquid outlet port,
the gas inlet port is combined with the gas outlet port,
the device comprises a plurality of fluid storage containers, and comprises a set of valves on the gas inlet and outlet ports and a set of valves on the liquid inlet and outlet ports, which allow selecting the containers where the gas is injected and the containers where the gas is discharged.

Advantageously, the device uses air and water, which are widely available and inexpensive.

A fourth aspect of the invention proposes that the device allows a combined use. Here, the discharge facility comprises an expansion facility, containing at least one pressure reducer and an electric generator for producing electrical energy by the expansion of the compressed gas. The discharge facility may further comprise an industrial facility, connected to the expansion facility in order to use the expanded gas in an industrial process, or connected to the gas outlet port in order to use the compressed gas in an industrial process.

Thus, regardless of the device for storing and delivering a gas, instead of releasing the expanded gas after the energy is produced, the gas can be used in an industrial process at a specified pressure and possibly after expansion, so there is no need for additional structures. By implementing a device for storing and delivering compressed gas directly at an industrial site, not only is it possible to produce the energy required by the facilities on site, but also to provide them with gas.

Optionally, the discharge facility may comprise means for bringing the gas to the pressure required by the industrial facility in order to deliver the gas at a given pressure at a low cost.

In a particularly advantageous embodiment, the liquid discharge means includes a generator group connected to the liquid outlet port, the generator group comprising a turbine and a generator, the discharged liquid passing through the turbine for the generation of electrical energy by the generator.

A system for regulating and controlling the motor group and a system for regulating and controlling the generator group allow controlling their respective power and controlling the pressure in the fluid storage container, to accommodate different operating modes.

In this case, a fifth aspect of the invention proposes a method for storing and delivering a compressed gas in a device as described above, comprising the following steps:
a gas storage step, comprising the following operations:
   compressing the gas in the compression facility,
   injecting gas into the fluid storage container through the gas inlet port,
   simultaneously with injecting the gas, discharging liquid towards the generator group through the liquid outlet port, with the system for regulating and controlling the generator group in order to discharge the liquid maintaining a constant pressure in the fluid storage container,
a gas delivery step, comprising the following operations:
   injecting liquid from the source of liquid through the liquid inlet port into the fluid storage container,
   simultaneously with injecting the liquid, expelling gas towards the discharge facility, with the system for regulating and controlling the motor group in order to inject the liquid maintaining a constant pressure in the fluid storage container.

This operating mode, referred to as the main operating mode, allows storing and delivering the gas at a substantially constant pressure throughout all steps, which is particularly advantageous for producing energy but also for supplying gas to an industrial facility.

The storage step and the delivery step can take place simultaneously.

Various transitional modes which only last a few minutes or a few dozen minutes can be implemented by the device.

A transitional mode can be applied in a method for starting up the device from a state in which the motor group, the generator group, the compression facility, and the expansion facility are shut down and in which the fluid storage container contains compressed gas and liquid, said method comprising the steps of:
recognizing a request for a level of energy,
starting up the expansion facility and increasing its power to the requested level of energy, by discharging gas from the fluid storage container,
simultaneously with the previous step, starting up the generator group and increasing its power, thereby generating the requested energy by discharging liquid from the fluid storage container, the system for regulating and controlling the generator group controlling the pressure drop in the fluid storage container,
progressively decreasing the power of the generator group as the power of the facility is increased, the generator group being shut down when the expansion facility is producing the requested energy,
after the preceding step, starting up the motor group and increasing its power simultaneously with increasing the power of the expansion facility, the system for regulating and controlling the motor group controlling the increase in pressure in the fluid storage container until the desired pressure is reached,
carrying out the storage and delivery method.

The energy is thus quickly produced by using the hydraulic portion to ramp up the power very quickly when so ordered. A transitional operating condition can also be implemented when the device is in the gas delivery stage and a higher energy level is requested than the device is providing. For this purpose a transitional step is implemented which comprises the following operations:
recognizing a request for a level of energy exceeding what is being supplied by the expansion facility,
increasing the power of the expansion facility,
simultaneously with the above step, reducing the power of the motor group to allow the device to provide more energy,
if the power of the motor group is reduced until it shuts down and the requested level of energy has not been reached by the device:
   turning on the generator group and increasing its power in order to supply the requested level of energy by discharging liquid through the liquid outlet port of the fluid storage container,
   when the device reaches the requested level of energy, progressively reducing the power of the generator group as the power of the expansion facility increases,
   when the generator group shuts down, turning on the motor group and increasing its power simultaneously with increasing the power of the expansion facility in order to restore a given pressure in the fluid storage container,
otherwise, when the device reaches the requested level of energy, starting up the motor group and increasing its power simultaneously with increasing the power of the expansion facility in order to restore a given pressure in the fluid storage container,
resuming the operations of the delivery step.

Here again, the change in power from the device can be rapidly increased by temporarily using the hydraulic portion.

Similarly, a transitional operating mode can be applied when the device is in the gas storage stage. For this purpose, a transitional step is carried out which comprises the following operations:
recognizing a variation in the level of energy supplied to the compression facility,
when the variation is a decrease, increasing the power from the generator group to produce the necessary compensating energy for the compression facility by discharging liquid from the fluid storage container,
when the variation is an increase, increasing the power from the motor group to consume the energy not consumed by the compression facility by injecting liquid into the fluid storage container.

In this manner the device can accommodate significant and rapid variations in power from the power source.

The accompanying drawings illustrate the invention:

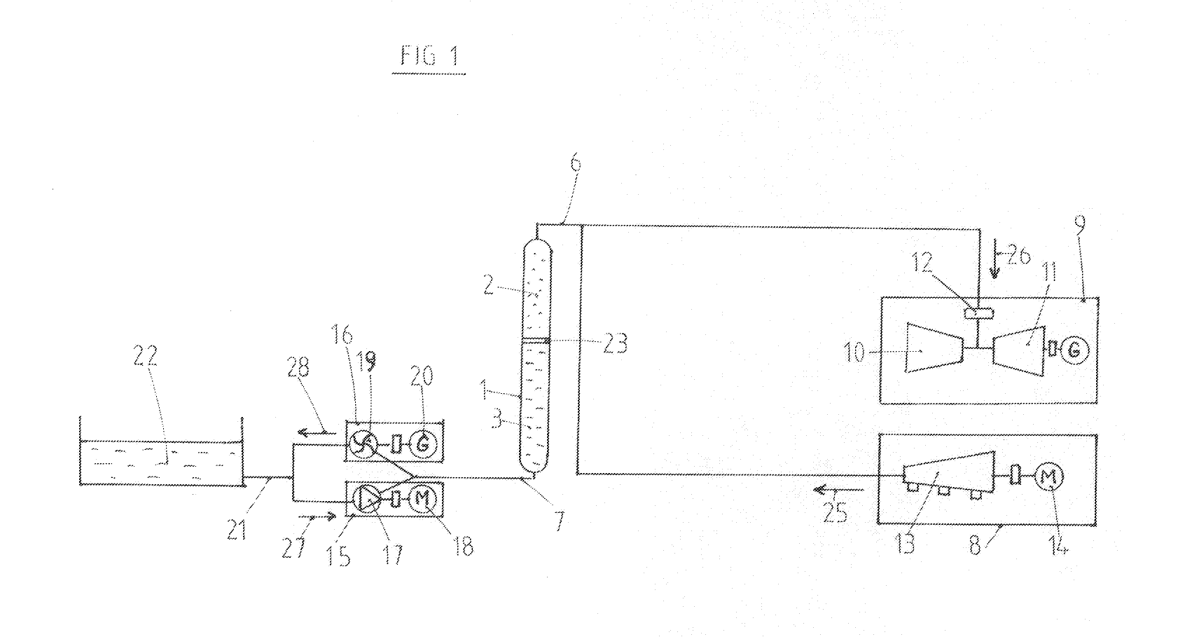

FIG. 1 shows a general diagram of the device for storing and delivering compressed gas according to the invention;

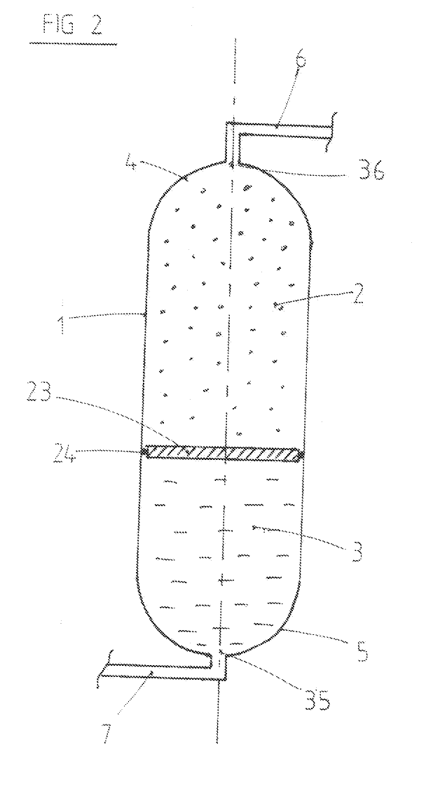

FIG. 2 shows a more detailed view of a fluid storage container;

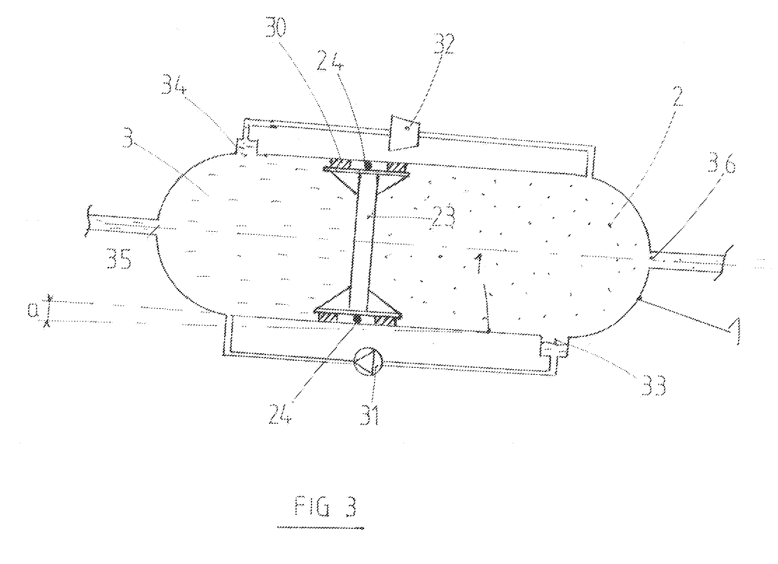

FIG. 3 shows an embodiment where the gas/liquid separation in the storage container is not in a horizontal plane;

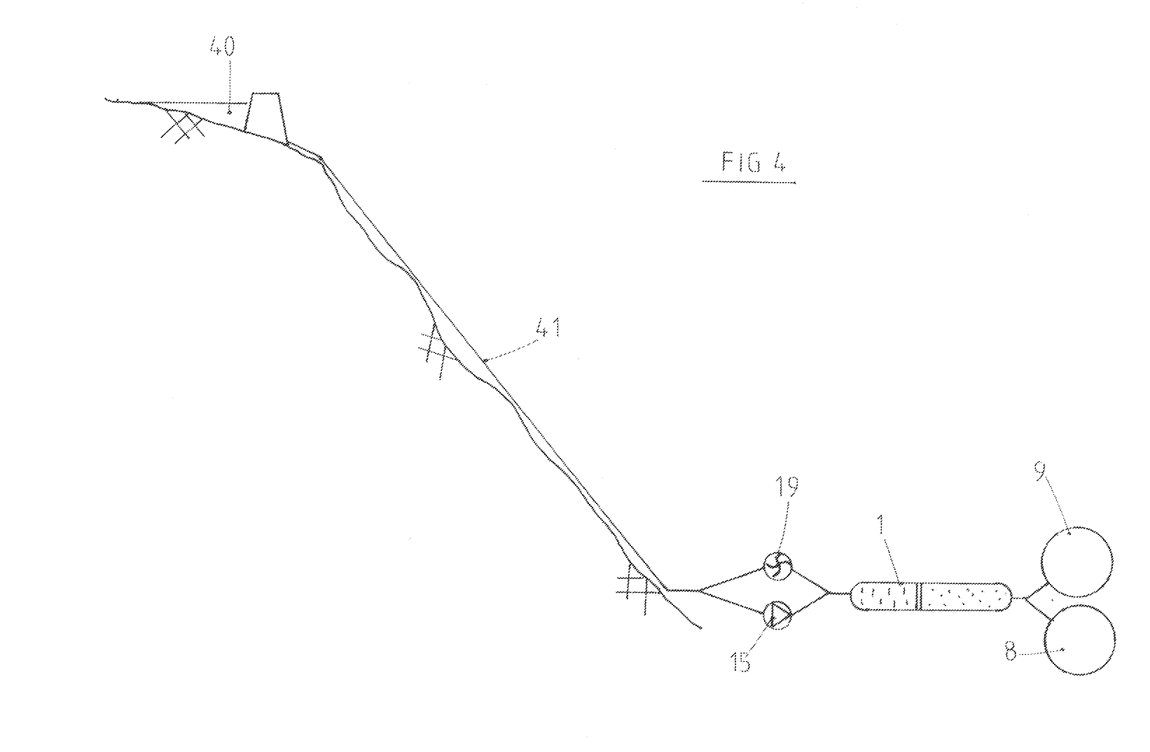

FIG. 4 shows an embodiment with a liquid reservoir located at a high altitude;

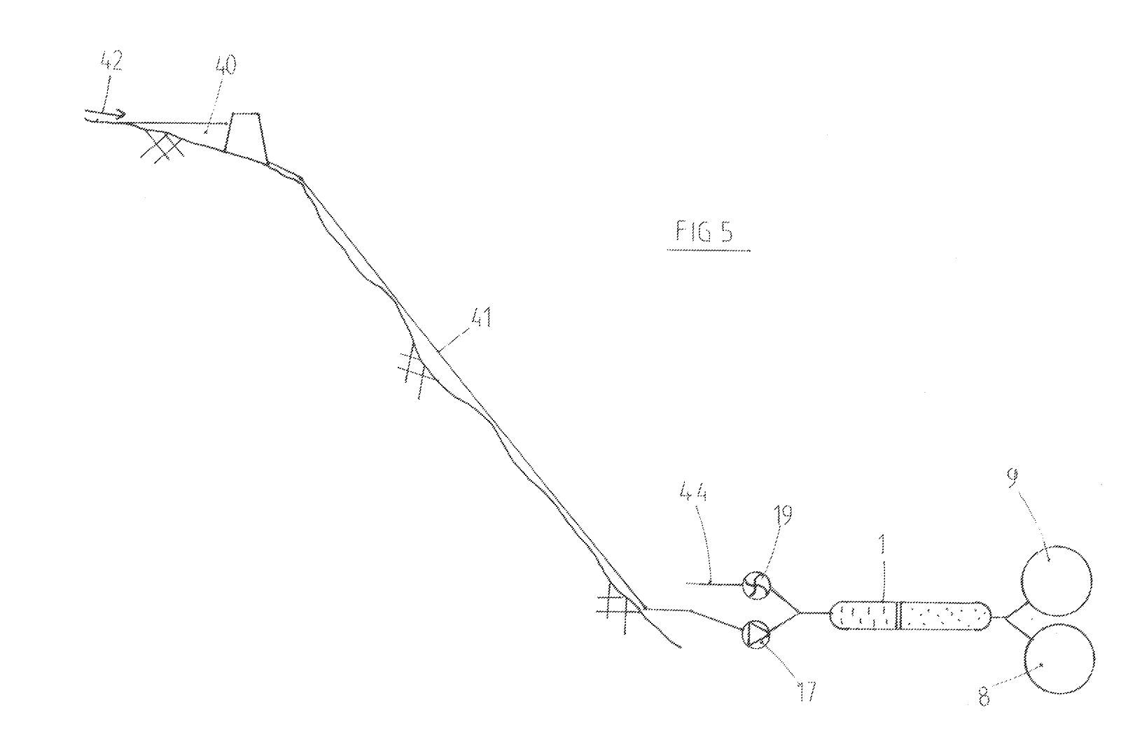

FIG. 5 shows an embodiment with a liquid reservoir located at a high altitude and the possibility of applying a turbine to external additions;

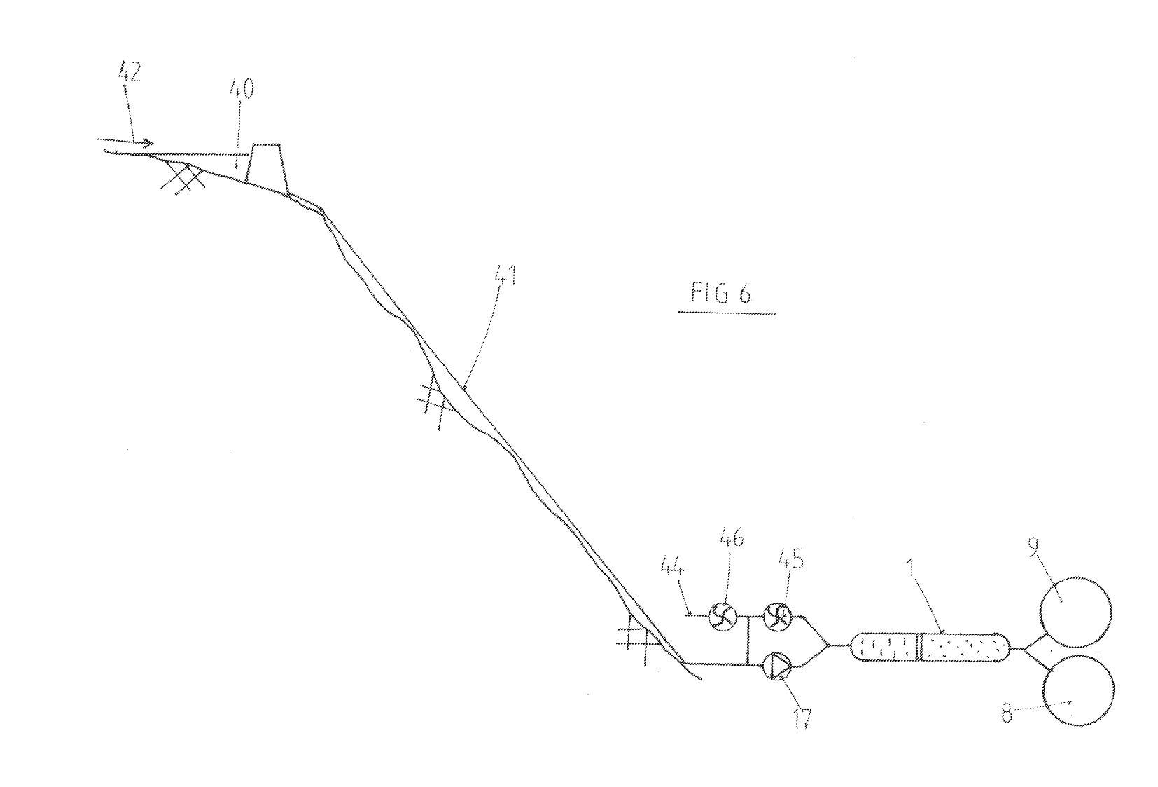

FIG. 6 shows an embodiment with a liquid reservoir located at a high altitude and a multi-stage turbine;

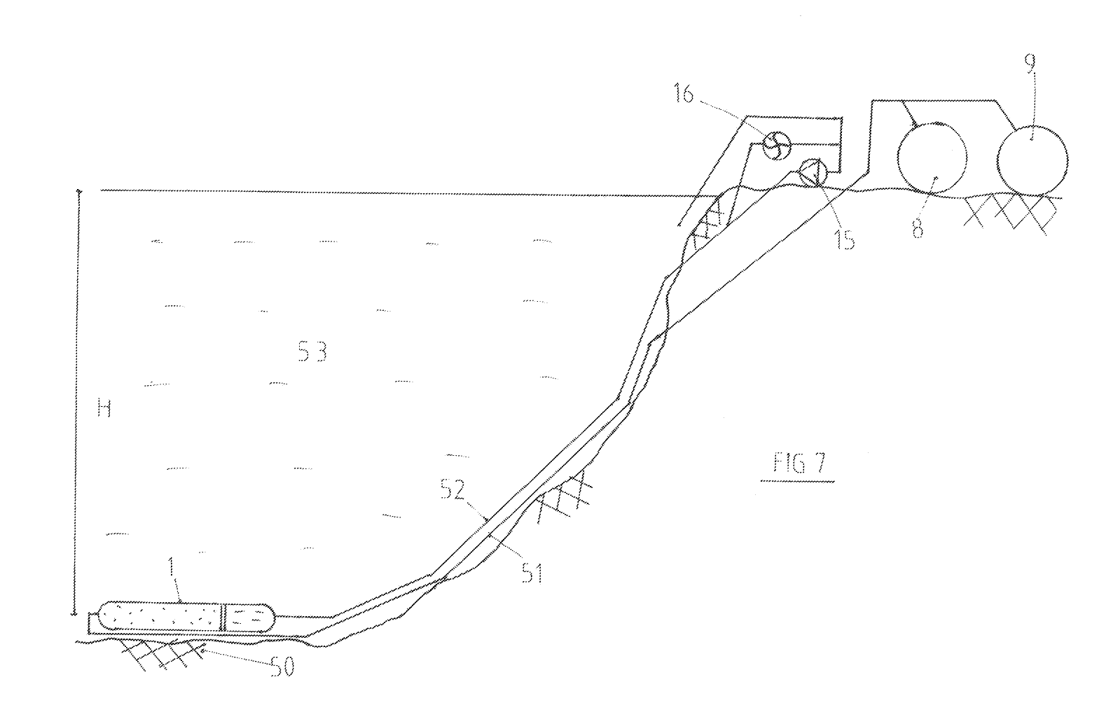

FIG. 7 shows an embodiment where the fluid storage container is underwater, placed on the bed;

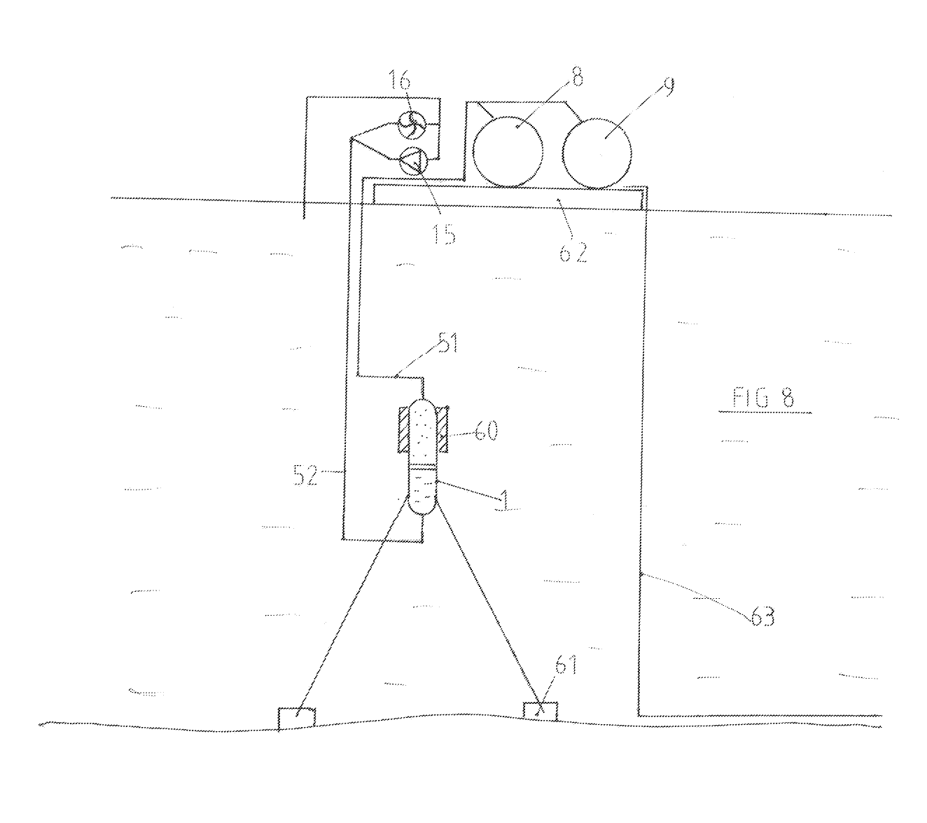

FIG. 8 shows an embodiment where the fluid storage container is underwater, between two bodies of water;

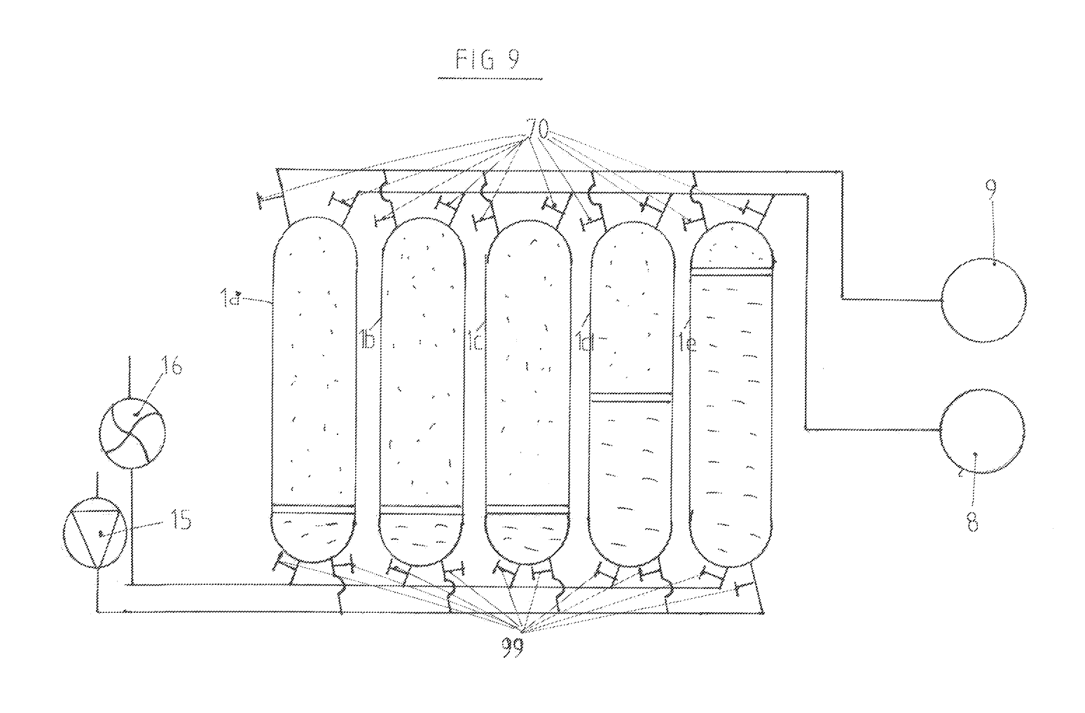

FIG. 9 shows an embodiment with several fluid storage containers;

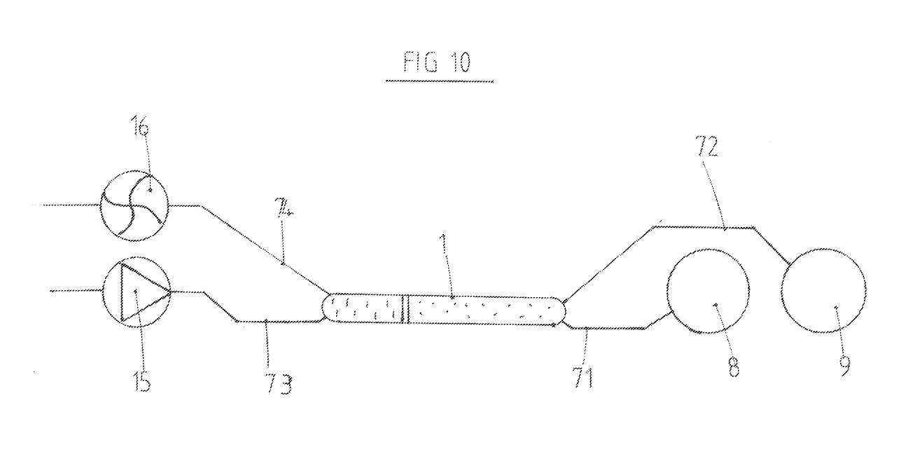

FIG. 10 shows an embodiment for smoothing the electrical energy;

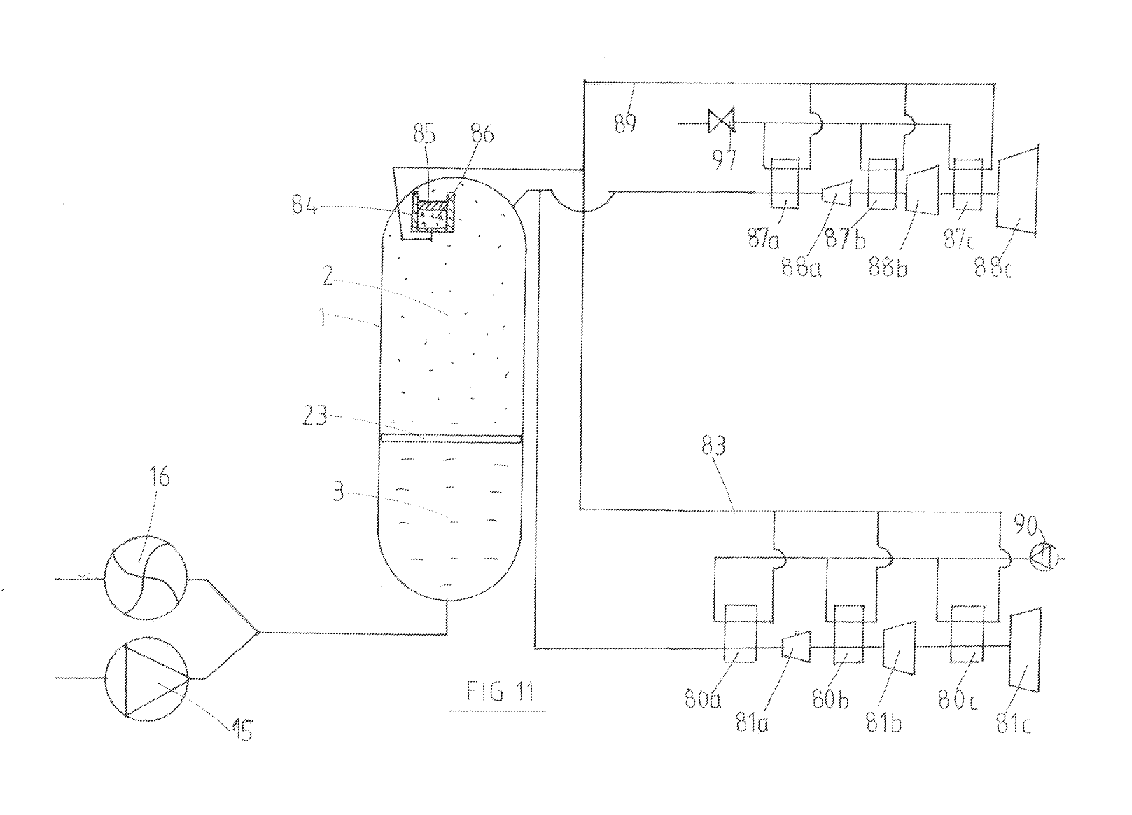

FIG. 11 shows a general diagram of the invention which incorporates heat storage inside a fluid storage container;

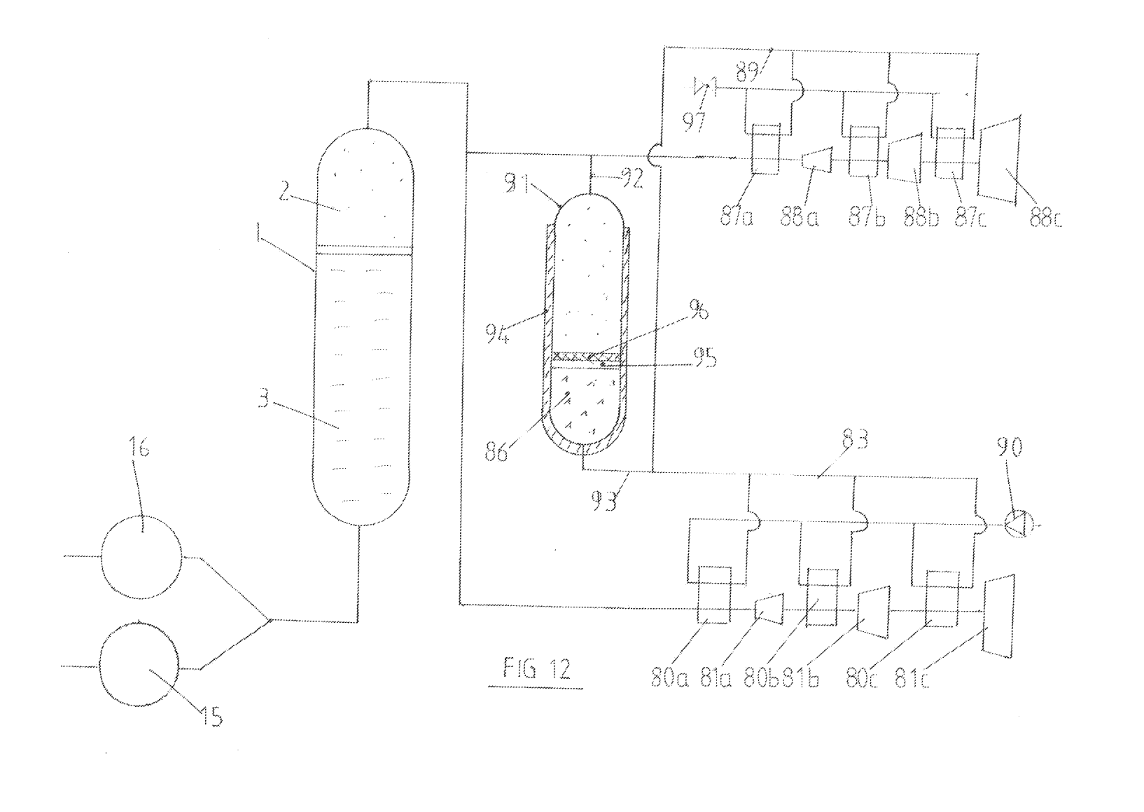

FIG. 12 shows a general diagram of the invention with heat storage outside the fluid storage container;

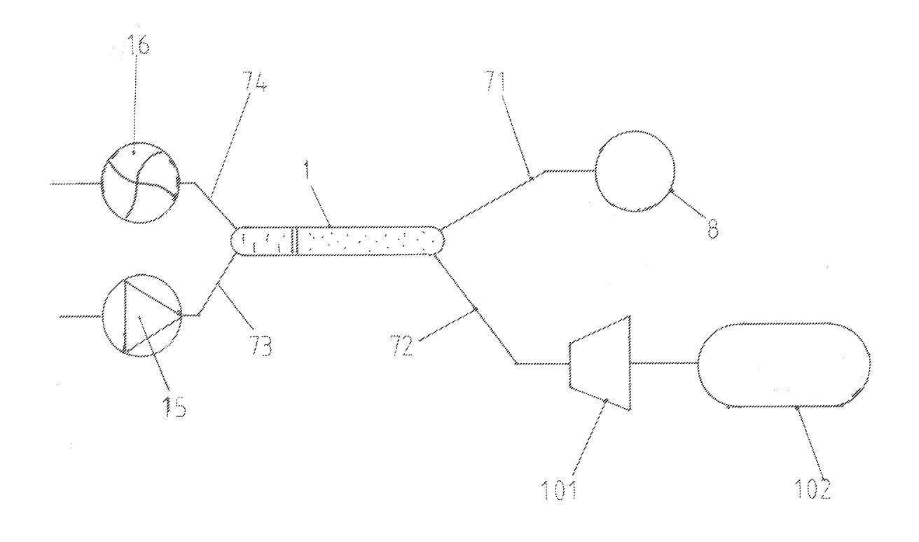

FIG. 13 shows the device of the invention, in which the discharge facility consists of an expansion facility which produces electrical energy, followed by an industrial application for the gas.

FIG. 1 shows a block diagram of a device for storing and delivering a gas according to one of the possible arrangements of the invention. The device comprises at least one rigid fluid storage container 1 in which the gas pressure is kept constant by a liquid. Advantageously, in what follows, the fluids used are air as the gas and water as the liquid, it being understood, however, that another gas and another liquid may be used.

The fluid storage container 1, shown in more detail in FIG. 2, may be made of steel, concrete, or composite materials. Its thickness and design are able to resist the internal pressure from the fluids it holds. The body of the fluid storage container 1 may be cylindrical and have ends 4 and 5 that are conventionally hemispherical or semi-elliptical in shape to provide better resistance to stresses from the pressure from the stored fluids.

The body of the fluid storage container 1 may, depending on the application, consist of steel pipes such as the ones used to convey pressurized gas. As examples, such a pipe of X80 steel, with a diameter of 1.4 m and sized to store air at 120 bar, has a wall thickness of approximately 40 mm; a pipe of X52 steel, with a diameter of 1.2 m and sized to store air at 80 bar, has a wall thickness of about 24 mm.

The capacity of the fluid storage container 1 can range from a few tens of m3 to tens of thousands of m3 depending on the application.

The container 1 is equipped with the supports necessary to maintain it.

The container 1 is equipped, near a first end, with at least one gas port 36 connected to a gas source and opening into a gas 2 containing portion in the fluid storage container 1, allowing the gas to flow into or out of the fluid storage container 1. FIGS. 1 to 8, 11 and 12 show an example in which the gas port 36 is both a gas inlet and outlet port of the fluid storage container 1, it being understood the gas outlet port can be separate from the gas inlet port, as will be seen below.

The gas port 36, in its capacity as gas inlet port, is connected via a pipe 6 that is resistant to the pressure of the gas 2 to at least one compression facility 8 which delivers the pressurized gas 2 to be stored when wanting to store the gas, and, as gas outlet port, to at least one discharge facility 9 which uses the pressurized gas 2 when wanting to deliver the air 2.

The compression facility 8 consists, in FIG. 1, of at least one air compressor 13 coupled to at least one electric motor 14, and allows producing and delivering compressed air at constant pressure to the fluid storage container 1 using electrical energy. The arrow 25 in FIG. 1 represents the direction of the gas flow at the outlet 8 from the facility.

The compression facility 8 could comprise a plurality of compressors and motors, arranged in parallel, each compressor being connected to the fluid storage container 1 by a gas inlet port specific to it. As a variant, the compression facility 8 comprises a plurality of compressors and motor arranged serially, the pressure of the compressors increasing from a first compressor supplied with low pressure gas to a last compressor connected to the gas inlet port 36 to the fluid storage container 1 in order to supply the fluid storage container 1 with compressed gas at the desired pressure.

The discharge facility 9 is for example, as illustrated in FIG. 1, an expansion facility and thus consists of at least one pressure reducer 10 coupled to at least one electric generator 11. A combustion chamber 12 advantageously allows warming the air entering the pressure reducer 10. The expansion facility 9 uses compressed air at constant pressure, delivered by the fluid storage container 1, to produce electrical energy. The arrow 26 in FIG. 1 represents the direction the air is flowing at the inlet to the expansion facility 9.

Similarly to the compression facility 8, the expansion facility 9 may comprise a plurality of pressure reducers and generators, for example arranged in parallel, the pressure reducers being supplied with compressed gas by a single gas outlet port or each with a gas outlet port of its own. The pressure reducers may also be arranged serially, from a first pressure reducer supplied with compressed gas from the fluid storage container 1 to a last pressure reducer supplying expanded gas at the desired pressure.

The device thus allows storing electrical energy in the fluid storage container 1 as compressed gas, such as compressed air, supplied by the compression facility 8 and allows recovering this electrical energy by expansion of the gas in the expansion facility 9.

Alternatively, the discharge facility 9 uses the compressed gas directly, for example in an industrial process. Examples in industry which apply methods using compressed gas have been cited in the introduction.

The fluid storage container 1 has, near a second end, at least one port 35 for liquid which opens into a liquid containing portion 3 of the fluid storage container 1, to allow the flow of liquid into and out of the fluid storage container 1.

In FIGS. 1 to 8, 11 and 12, the port 35 for the liquid is both a liquid input and output port. However, as will be seen below, the fluid storage container 1 may comprise a separate liquid inlet port and liquid outlet port.

To maintain the compressed gas 2 at a constant pressure in the fluid storage container 1, the port 35 serving as liquid inlet port is connected by a pipe 7 that is resistant to the pressure of the liquid to a motor group 15 comprising at least one pump 17 and at least one motor 18. Discharge means connected via pipe 7 to the liquid outlet port 35 allows liquid to be discharged from the fluid storage container 1. In a preferred embodiment, the discharge means includes at least one generator group 16 comprising a turbine 19 coupled to at least one electric generator 20.

In the figures, the device for storing and delivering gas is represented as comprising a single motor group 15 and a single generator group 16. However, the device may include several motor groups 15 connected to the liquid port 35, for example arranged serially, or each connected to its own liquid inlet port, and therefore arranged in parallel. Similarly, the storage device may comprise several generator groups 16 mounted in parallel and connected to the same liquid outlet port, or arranged serially and each connected to its own liquid outlet port.

Arrow 27 in FIG. 1 represents the direction of flow of the liquid through the pump 17. The pump 17 is connected by a pipe 21 to at least one liquid reservoir 22 upstream. Thus, in the case where the device includes multiple motor groups 15, one source of liquid can supply each pump of each motor group 15, or there can be several sources of liquid which supply one or more pumps independently.

Arrow 28 in FIG. 1 represents the direction of flow of the liquid through the turbine 19. The turbine 19 is advantageously connected by a pipe 21 to the liquid reservoir 22 downstream.

The operation of a storage device in which the gas is air and the liquid is water is now described.

During a step referred to as the air storage step, the air supplied at an input pressure by the compression facility 8 enters the air-containing portion 2 of the fluid storage container 1, through the port 36 for the air, and remains at a storage pressure that is very close to the input pressure. The air then exerts on the water 3 a storage pressure that is very close to the input pressure, either directly, or as will be seen below, via separation means between the air and the water 3, such as a diaphragm 23.

Under the effect of this air pressure, water 3 is discharged from the bottom part of the fluid storage container 1 through the water port 35.

In the preferred embodiment, the water drained in this manner drives the hydraulic turbine 17 of the generator group 16, which produces electrical energy. A system for regulating and controlling the generator group 16 allows maintaining the air at a constant pressure throughout the air storage operations.

During a step referred to as the air 2 delivery step, water 3 is pumped by the hydraulic pump 17 of the motor group 15 at a pressure substantially equal to the stored pressure in the fluid storage container 1, and enters the bottom part of the fluid storage container 1 through the port 35 at a pressure very close to the storage pressure. The water then exerts a pressure very close to the storage pressure on the air 2 in the fluid storage container 1.

Under the effect of the pressure exerted by the water, air is discharged from the fluid storage container 1 through the air port 36 and is fed at a constant pressure very close to the storage pressure to the discharge facility 9. A system for regulating and controlling the motor group 15 allows maintaining a constant gas pressure throughout the gas delivery operations.

FIG. 4 represents a variant in which a reservoir 40 of liquid located at a higher altitude than that of the fluid storage container is used to supply the device with liquid. The reservoir 40 of liquid may then be, for, example a hydraulic reservoir such as a natural or artificial water storage basin, located higher than the fluid storage container 1. In this configuration, the hydraulic pump 17 is fed with water, via a pipe 41, by the hydraulic reservoir 40. The pump 17 then only needs to raise the water pressure by the difference between the pressure inside the fluid storage container 1 and the pressure corresponding to the difference in altitude between the hydraulic reservoir 40 and the hydraulic pump 17. The energy to be supplied to the pump 17 is reduced accordingly. The turbine 19 is also connected to the hydraulic reservoir 40 by the same pipe 41 that connects the pump 17 and the hydraulic reservoir 40, to allow returning to the hydraulic reservoir 40, when storing air in the fluid storage container 1, the water extracted by the pump 17 when air was being discharged from the fluid storage container 1.

FIG. 5 shows a variant of the previous case, where the reservoir 40 of liquid is fed additional externally supplied water 42. This may be, for example, a river which supplies water to the hydraulic reservoir 40. It is then possible to use the turbine 19 on the additional externally supplied water 42 from the hydraulic reservoir 40. In this case, the water exiting the turbine 19 is discharged 44 at the height of the turbine 19 in the open air and the turbine 19 can either be supplied directly by the pump 17 or be supplied with water 3 that has passed through the fluid storage container 1.

It is also possible, as shown in FIG. 6, to have a separate hydraulic turbine facility comprising two turbine stages 45 and 46 which allows both turbine stages 45, 46 to be supplied by the fluid storage container 1, and for a single downstream turbine stage 46 corresponding to the difference in altitude between the hydraulic reservoir 40 and the downstream turbine stage 46 to be fed directly by the hydraulic reservoir 40.

Utilizing the device of the invention to store electrical energy using the water stored in the hydraulic reservoir 40, the arrangements shown in FIG. 5 and FIG. 6 allow the turbine to produce electricity via the additional externally supplied water 42 without requiring any additional facilities.

FIG. 7 shows a variant in which the fluid storage container 1 is installed underwater, for example in the sea 53, placed on the seabed 50. Pipes 51 connecting the fluid storage container 1 with the air compression facility 8 and the discharge facility 9, which are located on land on the coastline, follow the slope where they are laid. Similarly, pipes 52 connecting the fluid storage container 1 with the motor group 15 and the generator group 16 are laid to follow the slope. As shown in FIG. 7, the portion of the pipes 51, 52 located near the surface can be underground in order to protect the pipes 51, 52 from sea swell and avoid damaging the coastline. The water can be pumped and fed to the turbine directly from the sea 53, as shown, or from a reservoir located on land and supplied with seawater or freshwater.

At a same storage pressure as a land-based facility, such an underwater arrangement of the fluid storage container 1 reduces the stresses on the fluid storage container 1, as the water in which the fluid storage container 1 is submerged exerts an external counter-pressure proportional to the underwater depth H of the fluid storage container 1. It is then possible to reduce the thicknesses of the walls of the fluid storage container 1 accordingly.

In FIG. 8, the fluid storage container 1 is positioned in midwater. It is held in this position due to its positive buoyancy which exerts an upward force while anchorages 61 to the bed hold it down. The buoyancy of the container is provided by buoyancy elements 60 integrated into its design. The compression facilities 8 and the air discharge facility 9 as well as the motor group 15 and generator group 16 for the water are installed on a floating structure 62. The facilities 8, 9 can be connected to an electrical grid on land by an underwater electrical cable 63.

FIG. 9 shows an application of the device of the invention in which several containers are used, in this case five fluid storage containers 1a-1e. This variant increases the volume of air stored and thus the amount of electrical energy stored. The transverse dimension, for example the radius if the container has a circular cross-section, of each of the fluid storage containers 1a to 1e is limited due to the high internal pressure and it may be necessary to use a set of containers if wanting to increase the storage capacity.

In the example shown, the fluid storage containers 1a-1e are all connected to the same air compression facility 8, to the same discharge facility 9, to the same motor group 15 and therefore to the same hydraulic pump 17, and to the same generator group 16 and therefore to the same hydraulic turbine 19. Of course, it can be arranged so that each fluid storage container 1a-1e is connected to a compression facility 8, a discharge facility 9, a motor group 15, and a generator group 16 which are specific to it.

A set of air valves 70 placed on the air inlet and outlet ports 36, and a set of water valves 99 placed on the water inlet and outlet ports, allow isolating certain connections. It is then possible to choose specific fluid storage containers 1a-1e to be involved in one air storage step, into which the air is injected and the pressure is kept constant by means of the system for regulating and controlling the generator group 16, while other containers are involved in an air delivery step, in which the gas is discharged and the pressure is kept constant by means of the system for regulating and controlling the motor group 15.

When storing electrical energy of poor quality (unstable or intermittent for example) from a source directly connected to the compression facility 8, this arrangement allows injecting into a grid perfectly stabilized electrical energy produced by the discharge facility 9, which then functions as an expansion facility.

FIG. 10 represents an application of the device of the invention which uses a single fluid storage container 1 and in which:
the compression facility 8 is connected to the fluid storage container 1 by a pipe 71 specific to it and an air inlet port specific to it,
the discharge facility 9 is connected to the fluid storage container 1 by a pipe 72 specific to it and an air output port specific to it,
the motor group 15 is connected to the fluid storage container 1 by a pipe 73 specific to it and a port specific to it, and
the generator group 16 is connected to the fluid storage container 1 by a pipe 74 specific to it and a port specific to it.

When producing and storing compressed air from a source of electrical energy of poor or varying quality (supplied by a wind farm for example), this arrangement allows producing stabilized electrical energy in the expansion facility 9 at the same time by discharging and expanding the compressed air. The fluid storage container 1 then acts to smooth the fluctuations in the electrical energy source.

For certain transitional operations that are detailed below, it is also possible to make use of the ability to use the device with the motor group 15 and the generator group 16 operating at the same time.

When using the device for storing and delivering electrical energy in the form of a compressed gas, different operating modes can be distinguished: a primary mode and a transitional mode.

In the primary mode, the device operates in two steps which may take place simultaneously:
a gas storage step, comprising the following operations:
   compressing the gas in the compression facility 8,
   injecting the compressed gas into the fluid storage container 1 through the gas inlet port 36,
   simultaneously with injecting the gas, discharging liquid towards the generator group 16 through the liquid outlet port 35, with the system for regulating and controlling the generator group 16 in order to discharge the liquid maintaining constant pressure in the fluid storage container 1,
a gas delivery step, comprising the following operations:
   injecting liquid from the source 22, 40 of liquid through the liquid inlet port 35 into the fluid storage container 1 by using the motor group 15,
   simultaneously with injecting the liquid, discharging gas towards the expansion facility 9, with the system for regulating and controlling the motor group 15 in order to inject the liquid maintaining a constant pressure in the fluid storage container 1.

This primary mode is used when the desired variations in the electrical power entering the device in the electrical energy storage step, or exiting the device in the electrical energy delivery step, are respectively compatible with the admissible rates of change in the power from the compression facility 8 and with the admissible rates of change in the power from the expansion facility 9.

Otherwise a transitional mode can be implemented, which temporarily increases the possible rate at which the power of the device can change before the primary operating mode is achieved, by adjusting the power of the motor group 15 and generator group 16.

A first case concerns device startup after shutdown, with fast load rampup when a level of energy is requested.

In the particular case of device startup after shutdown, meaning starting from a state in which the motor group 15, the generator group 16, the compression facility 8, and the expansion facility 9 are off, and in which the fluid storage container 1 contains gas and liquid, the regulating and control devices will first turn on the expansion facility 9 with the power changing at a rate that is compatible with this facility. In the event that the power does not ramp up quickly enough, for example when the level of energy is requested within a timeframe that is incompatible with the rates of change of the expansion facility 9, the generator group 16 will be placed in operation at the same time in order to generate additional electrical power and reach the requested energy level. The system for regulating and controlling the generator group 16 controls the pressure drop in the fluid storage container 1 due to the simultaneous discharge of gas and liquid.

Thus, the generator group 16 and the expansion facility 9 are temporarily in use at the same time. In effect, particularly in the case where the gas used is air and the liquid is water, the response time of the generator group 16 is much lower than that of the expansion facility 9, and therefore the generator group 16 provides a faster but temporary response to an urgent need for energy.

The pressure in the fluid storage container 1 then necessarily decreases. The generator group 16 will see its power gradually decrease until it shuts down while the power of the expansion facility 9 increases.

Simultaneously with the shutdown of the generator group 16, the motor group 15 is started up and its power is gradually increased until the pressure levels in the fluid storage container 1 corresponding to the primary operating mode are restored.

In the case where the device is already running in the primary operating mode, two scenarios are possible.

In the first scenario, the device is currently in an energy delivery step, but an increase in the energy level delivered by the expansion facility 9 is requested.

For example, this can concern cases where, during the step of delivering electrical energy to a grid, the level of energy delivered by the expansion facility 9 to the device must be increased very quickly in order to regulate the frequency or voltage in the grid or for any other case of ensuring grid stability.

The power of the expansion facility 9 should be increased gradually according to demand, at a rate compatible with the expansion facility 9. It may be that this speed is insufficient to meet the demand within a reasonable time. Then, advantageously, the power of the motor group 15, which injects water into the fluid storage container 1 in the primary operating mode, will be gradually reduced so that the device consumes less power and therefore provides more.

If, once the power from the motor group 15 is reduced to the point that it is shut down, the device still does not provide the required level of energy, the power from the generator group 16 will be quickly ramped up to provide the requested level of energy.

As the power from the expansion facility 9 is ramped up, it gradually replaces the power from the generator group 16 which is simultaneously decreasing until the generator group 16 shuts off. The pressure in the fluid storage container 1 has then dropped several bars, for example 4 bars.

When the generator group 16 is shut off, the motor group 15 is then restarted, and its power is ramped up simultaneously with increasing the power from the expansion facility 9, in order to return to a given pressure value 1 in the fluid storage container 1 corresponding to the primary operating mode.

In the second scenario, if the device is currently in an energy storage step, then in a similar manner the power from the energy source for the compression facility 8 may vary while the compressed gas facility 9 is injecting gas into the fluid storage container 1. For example, when the compression facility 8 is powered by solar power, this of course varies with the current meteorological conditions.

When there is a decrease in power from the energy source for the compression facility 8, the generator group 16, which can produce energy via the turbine 17 through which the liquid 3 is discharged from the fluid storage container 1, can rapidly increase its power in order to stabilize the power to the compression facility 8.

Similarly, when there is an increase in power from the energy source for the compression facility 8, the motor group 15, which is shut off during the storage operation when in the primary operating mode, is then quickly started up and the load is ramped up to consume some of the energy surplus not consumed by the compression facility 8.

Thus, the power from the motor group 15 and generator group 16 can be modified from the primary operating mode in order to allow significant rates of change in power; the device gradually returns to the primary operating mode.

The gas 2 in the fluid storage container 1 is preferably separated from the liquid 3 by means of fluid-tight separation means, such as a rigid and movable diaphragm 23 separating the fluid storage container 1 into a gas 2 containing portion and a liquid 3 containing portion. The diaphragm 23 then defines a separation surface between the liquid and gas, and can move with the changes in volume of the gas and liquid during the gas storage and delivery operations.

Indeed, the separation means must be able to move during the gas storage and delivery operations so that the volume of the gas containing portion decreases when gas is removed from storage while the volume of the liquid containing portion increases, and conversely, so that the volume of the gas containing portion increases when gas is stored while the volume of the liquid containing portion decreases.

The diaphragm 23 is preferably peripherally equipped with one or more seals 24 in order to maintain a separation between the pressurized gas and the liquid in the fluid storage container 1 and to avoid the phenomena of gas dissolving in the liquid or of one of the two fluids contaminating the other. Thus, the two fluids in the fluid storage container 1 exert mutual pressure on one another via the diaphragm 23.

The nature of the seals 24, particularly their material, shape and fluidtightness, is appropriate for the fluids 2, 3 and for the storage conditions such as pressure and temperature. It must also ensure a sufficient service life for the seals, particularly good wear resistance to the friction on the inner surface of the container resulting from the displacement of the diaphragm 23 during gas storage and delivery. The seals 24 may be inflatable seals. To increase the fluidtightness between the gas and liquid, at least two seals 24 can be used to form successive barriers.

In the case shown in FIG. 2, the separation surface between the air 2 and the water 3 is in a horizontal plane. Then the air 2 necessarily occupies the upper portion of the fluid storage container 1 and the water occupies the lower portion of the fluid storage container 1. The diaphragm 23 can then simply float on the surface of the water in a manner that allows it to move as the volume of water changes. Alternatively, the rigid separating diaphragm 23 may be replaced by a membrane of flexible material separating the air and water, so that the volumes of the gas containing portion and the water containing portion can vary by deformation of the membrane.

If the separation surface between the air and the water is not in a horizontal plane, it is necessary to use a rigid separating diaphragm 23 specially designed to accommodate the pressure differentials between the side containing the liquid and the side containing the gas.

FIG. 3 thus represents a particularly advantageous variant of a separation means between the gas and liquid in a fluid storage container 1, in which the separation surface between the gas and the liquid is not in a horizontal plane. For example, the separation surface is in a vertical plane or in a plane inclined by a few degrees, for example between 1° and 10°, relative to the vertical plane. This may be the case if it is more advantageous for the fluid storage container 1 to be horizontal, resting on the ground, buried, or when its lengthwise dimensions do not allow positioning it vertically. It is then necessary that the design of the diaphragm 23, in the plane of the separation surface between the gas 2 and the liquid 3, allows it to absorb the stresses due to differences in the pressure distribution on the liquid side and on the gas side while allowing it to slide within the body of the fluid storage container 1 and while maintaining the fluidtight seal.

The rigid diaphragm 23 is thus equipped on its rim with bearing surfaces 30 which press against the body of the fluid storage container 1, these bearing surfaces 30 having large dimensions so that they are offset to each side of the plane of the diaphragm 23, and therefore are offset from the separation surface between the gas and the liquid, in order to absorb the stresses from the applied forces. These bearing surfaces 30 are made of a material resistant to the compression by the pressure in the fluid storage container 1 and which facilitates the sliding of the diaphragm 23 along the body of the fluid storage container 1 to allow displacement of the diaphragm.

The bearing surfaces 30 may be continuous around the entire circumference of the container, may be discontinuous but evenly distributed around the circumference of the container, or may be discontinuous and unevenly distributed, for example with a greater total supporting surface area on the lower and upper parts of the container where the pressure exerted by the fluids on the diaphragm 23 is the highest.

Similarly, the width of the bearing surfaces 30 may or may not be constant along the circumference of the container. In the case of discontinuous bearing surfaces, the unit area of contact between the bearing surfaces and the container may be the same for all the bearing surfaces or may differ according to the bearing surface.

The supports may also include roller mechanisms such as wheels to facilitate diaphragm movement.

The offset of the bearing surfaces 30 relative to the plane of the diaphragm 23, meaning the greatest distance between a point on a bearing surface 30 and the plane of the diaphragm 23, may not be the same for all the bearing surfaces 30. It may be greater for the bearing surfaces 30 placed in the lower portion of the container, because of the higher pressure exerted by the water on the lower portion of the diaphragm 23.

The diaphragm 23 is then perfectly centered in the fluid storage container 1, meaning it is not tilted by the pressures on its two sides, and the seal or seals 24 remain properly in place, even during diaphragm movement during storage and delivery operations.

Depending on their type, the bearing surfaces 30 may also contribute to the fluidtightness between the gas and the liquid.

A diaphragm 23 equipped in this manner with bearing surfaces 30 ensures fluidtightness between the two fluids in any fluid storage container 1, while allowing the volume of the portion containing the first fluid and the volume containing the second fluid to vary by displacement of the diaphragm 23.

In the case where the separation surface between the gas and the liquid is inclined by a few degrees relative to the vertical plane, it is advantageous to have the fluid storage container 1 so that the bottom part 33 is the gas containing portion and therefore the top part 34 is the liquid containing portion. Then, if there is a failure in the diaphragm 23 and/or seals 24 between the gas and the liquid, any leakage of the liquid 3 towards the gas 2 through the diaphragm 23 must flow towards the bottom part 33 of the fluid storage container 1, where the liquid can be recovered and returned to the other side of the diaphragm 23 (the liquid containing portion) by a low-power hydraulic pump 31. Similarly, any leakage of gas into the liquid through the diaphragm 23 must flow towards the top part of the fluid storage container 1, into the liquid containing portion. This gas can be returned to the other side of the diaphragm 23 (the gas containing portion) by a low-power air compressor 32.

The bottom part 33 and the top part 34 of the fluid storage container 1 are positioned at opposite ends of the container 1 so that they do not interfere with the movement of the diaphragm 23.

FIGS. 11 and 12 represent another arrangement of the invention, which allows storing the gas and delivering it in an adiabatic cycle, particularly in the case where the gas is expanded by the expansion facility 9 to produce electric energy.

For this purpose, a heat exchange system is associated with the compression facility 8 and with the expansion facility 9. The heat exchange system comprises means for extracting the heat generated during gas compression in the compression facility 8, means for storing the heat, and means for delivering this heat to the gas in the expansion facility 9. The cycle of compression and expansion becomes an “adiabatic” cycle with benefits in terms of improved performance and a complete absence of CO2 emission, with no risk to the environment.

In the examples shown in FIGS. 11 and 12, the compression facility 8 includes at least one stage, for example, three compression stages 81a to 81c, each compression stage 81a to 81c being associated with at least one heat exchanger 80a to 80c, for example at the outlet from each compression stage 81a to 81c, to recover the heat from the gas during or after the compression in each compression stage 81a and 81c and to transfer it to a heat transfer fluid 86. The compression stages 81a to 81c, each associated with a heat exchanger 80a to 80c, may be arranged serially or in parallel.

Similarly, the expansion facility 9 includes at least one stage, for example three gas expansion stages 88a to 88c, each expansion stage 88a to 88c being associated with at least one heat exchanger 87a to 87c, for example placed at the inlet to each expansion stage 88a to 88c, to recover the heat from the heat transfer fluid 86 and to transfer it to the gas before or during the expansion in each expansion stage 88a to 88c. The expansion stages 88a to 88c, each associated with a heat exchanger 87a to 87c, may be arranged serially or in parallel.

The heat exchange system then comprises at least one heat reservoir 84, 91 for storing the heat transfer fluid heated by the gas compression in the compression facility 8. The heat reservoir 84, 91 is thermally insulated and includes means for pressurizing a heat transfer fluid 86.

In a first example shown in FIG. 11, the heated heat transfer fluid 86, coming from the exchangers 80a to 80c of the compression facility 8, passes through a thermally insulated pipe 83 and fills the heat reservoir 84, preferably also thermally insulated, placed in the gas containing portion 2 in the fluid storage container 1, in a manner that does not interfere with the movement of the diaphragm 23. The means for pressurizing the heat transfer fluid include, as shown in FIG. 11, a thermally insulated plunger 85 positioned as an interface between the gas in the fluid storage container 1 and the heat transfer fluid 86 in the heat reservoir 84, 91. The heat transfer fluid 86 is therefore maintained at the pressure of the compressed gas 2 in the fluid storage container 1. Advantageously, as will be seen below, the heat transfer fluid 86 is water. Given the significant heat capacity of water, the storage volume for water as a heat transfer fluid 86 in the fluid storage container 1 will not exceed a few percentage points of the air storage volume. The heat loss therefore remains very limited.

Each exchanger 87a to 87c of the expansion facility 9 is supplied with heat transfer fluid 86 from the heat reservoir 84 inside the fluid storage container 1 and is connected to the fluid storage container 1 by a thermally insulated pipe 89.

A pump 90 pressurizes the heat transfer fluid 86 at the inlet to the exchangers 80a to 80c of the compression stages 81a to 81c. A pressure reducer 97 allows the heat transfer fluid 86 to expand at the outlet from the heat exchangers 87a to 87c. The storage of the heat transfer fluid 86 in the heat reservoir 84 located in the fluid storage container 1 occurs at the same time as the storage of the gas 2 in the fluid storage container 1. The generator group 16 comprising the turbine 19 controlled by a regulating system maintains a constant pressure inside the fluid storage container 1 during this operation.

Delivery of the heat transfer fluid 86 from the heat reservoir 84 located in the fluid storage container 1 occurs at the same time as delivery of the gas 2. The motor group 15 comprising the pump 17 controlled by a regulating system maintains a constant pressure inside the fluid storage container 1 during this operation.

In a second example illustrated in FIG. 12, the heat reservoir 91 for storing the heat transfer fluid 86 is not located inside the fluid storage container 1 but is outside it. The heat reservoir 91 comprises a portion supplied with heat transfer fluid 86 and a portion supplied with compressed gas from the fluid storage container 1, the two portions being respectively located on each side of a diaphragm 95 placed in the heat reservoir 91 to establish a seal between the two portions.

More specifically, the heat reservoir 91 consists of a rigid container that can withstand the working pressure at the storage temperature of the heat transfer fluid 86, and it is equipped at one end, for example an upper end, with at least one gas inlet and outlet port, for a gas such as air, and at the other end, therefore the lower end, with at least one inlet and outlet port for the heat transfer fluid 86.

The gas inlet and outlet port of the heat reservoir 91 is connected by one or more pressure-resistant pipes 92 to the portion of the fluid storage container 1 containing the compressed gas 2, which allows maintaining a constant pressure in the heat reservoir 91 equal to that of the gas 2 in the fluid storage container 1. Alternatively, the gas from the fluid storage container 1 is, prior to its entry into the heat reservoir 91, expanded to a pressure substantially greater than the vaporization pressure of the heat transfer fluid 86 at its storage temperature. This prior expansion is particularly advantageous in the case where the heat transfer fluid is water, in order to maintain the water in its liquid state and facilitate its storage in the heat reservoir 91.

The inlet and outlet port for the heat transfer fluid 86 is connected by one or more pressure-resistant pipes 93 to a pipe 83 from the heat exchangers 80a to 80c of the compression facility 8, as described above, and to a pipe 89 from the heat exchangers 87a to 87c of the expansion facility 9, as described above. The heat reservoir 91 includes thermal insulation means 94.

The diaphragm 95 of the heat reservoir 91 also comprises thermal insulation means 96, and may for example float on the heat transfer fluid 86, its function being to separate the compressed gas, such as air 2, from the heat transfer fluid 86, such as hot water. The diaphragm 95 of the heat reservoir 91 may be peripherally equipped with seals. The diaphragm 95 of the heat reservoir 91 may have a design similar to what was described for the diaphragm 23 of the fluid storage container 1.

In the examples shown in FIG. 11 and FIG. 12, the heat transfer fluid 86 is preferably pressurized water and the compressed gas 2 is air.

The compression stages 81a to 81c are then arranged so that the temperature of the air exiting each compression stage 81a to 81c is substantially less than the vaporization temperature of water at the pressure prevailing in each exchanger 80a to 80c.

The water therefore remains in the liquid state in the heat exchanger 80a to 80c, and the pressurized hot water exits each exchanger 80a to 80c via the thermally insulated pipe 83 and flows to the heat reservoir 84, 91.

The heat exchange system thus allows using water as the heat transfer fluid 86, with the advantages mentioned in the introduction.

FIG. 13 shows an application of a device for storing compressed gas, in particular a device according to the present invention, wherein the discharge facility 9 consists of a gas expansion facility 101 at the outlet from the fluid storage container 1 which allows bringing the gas pressure down from the high pressure in the fluid storage container 1 to a lower pressure as it exits the expansion facility 101, and an industrial facility 102 which implements a method using compressed gas, the lower pressure of the gas as it exits the expansion facility 101 corresponding to the pressure at which the gas is used in the industrial facility 102. This expansion facility 101 is coupled to a generator which allows producing electrical energy.

More specifically, to avoid losing the energy required when compressing to a storage pressure higher than the operating pressure of one or more industrial processes requiring gas at a moderate pressure, it is advantageous for the discharge facility 9 to consist of the following:
an expansion facility 101 for expanding the gas from its storage pressure to the pressure at which it is used in the industrial process for energy production. This expansion facility may also be supplied with heat from the stored heat originating from gas compression or from any other heat source available at the site, particularly from the industrial processes involved, so that the gas is delivered at the proper temperature for the industrial process(es). Similarly, the heat losses due to expansion of the gas can advantageously be used either in industrial processes, such as a gas liquefaction process, or after storage can be used for cooling the air in the compression facility 8.
one or more industrial facilities 102, meaning those implementing industrial processes that use the pressurized gas as it exits the expansion facility.

Thus the expansion operation in the expansion facility 101 generates electrical energy. The expanded gas is then not released into the atmosphere but is advantageously used by the industrial facility 102.

In this particular case, the gas was not heated by a heat source before or during its expansion. Its temperature as it exits the expansion facility 101 is therefore less than its storage temperature in the storage container 1, which allows the use of the expanded gas as a coolant either directly in the industrial process in the industrial facility 102 or in any other process.

As a variant, the industrial facility 102 is directly connected to the gas outlet port 36 of the fluid storage container 1, so that the compressed gas is utilized directly.

Optionally, means can be used to bring the gas to the pressure required by the industrial facility 102.

The device can be positioned in different variants, and the fluid storage container 1 can be on land or underwater.

The device can thus be used to store gas intended for supply to an industrial process.

As the gas is maintained at a constant pressure during storage and delivery, this provides very favorable conditions for the operation of the compression facility 8 and the discharge facility 9.

The storage densities are also much higher than a storage at constant volume, because of the high pressures permitted in the fluid storage container 1.

It should also be noted that the usual pressures for using gases in industrial processes generally vary from a few bars to several tens of bars. Gas storage at these relatively low pressures would be at a low density, involving high storage costs and occupying a large amount of space.

It is much more advantageous to store the gas at high pressure.

The absence of an economically attractive means of gas storage forces manufacturers to produce the compressed gas at the time of use in the industrial process. It is therefore necessary to design a compression system specific to the gas pressures required by the industrial process in order to meet the ad-hoc needs of specific steps of the process, while this power could be greatly reduced by operating the compression facility continuously, or at least over a long period. In addition, any shutdown of the compression facility causes the entire industrial system to shut down, which means backup compression facilities must be made available.

An additional advantage of the gas storage according to the invention is therefore present when the gas is intended for use in an industrial process.

The device of the invention thus allows storing the gas at a high pressure and at satisfactory densities.

It may also be advantageous to use any available source of pressurized gas in the industrial process(es) to supply, even partially, the compression facility 8, and thus to reduce the energy consumed by the device.

In the event that another industrial process implemented at the industrial site, in addition to the first, requires a limited flow of gas stored at a high pressure which is closer to that of the stored gas, it is advantageous to place a bypass circuit between the gas outlet port 36 of the fluid storage container 1 and the expansion facility 9, to allow supplying a higher pressure to this other process in parallel. This bypass circuit could include a means for expanding the gas to the pressure required by the process.

The equipment according to the invention thus can supply gas at very different pressures to both industrial processes, simultaneously or alternatively.

1-30. (canceled)

31. Device for storing and delivering fluids, said fluids comprising a gas and a liquid, said device comprising:
at least one fluid storage container comprising a gas containing portion and a liquid containing portion,
an inlet port connected to a gas source and an outlet port for the gas, opening into said gas containing portion of said fluid storage container,
a liquid inlet port and outlet port, opening into said liquid containing portion of said container,
at least one compression facility connected to a gas source and to said gas inlet port, for injecting compressed gas at a storage pressure into said fluid storage container;
at least one discharge facility connected to said gas outlet port, for discharging the compressed gas,
means for discharging the liquid,
said device being characterized in that it further comprises
at least one motor group, connected to a source of liquid and to said liquid inlet port, said motor group comprising at least one pump and at least one motor for injecting the pressurized liquid into said fluid storage container through said liquid inlet port.

32. Device according to claim 31, comprising separation means between the gas and the liquid in said fluid storage container.

33. Device according to claim 32, wherein said separation means comprise a flexible membrane that can deform under the pressure in said fluid storage container.

34. Device according to claim 32, wherein said separation means between the gas and the liquid comprise a rigid and movable diaphragm defining a separation surface between the liquid and the gas in the fluid storage container, said diaphragm comprising bearing surfaces pressing against the fluid storage container, the bearing surfaces being offset to each side of the separation surface.

35. Device according to claim 34, wherein said diaphragm is peripherally equipped with seals.

36. Device according to claim 34, wherein said bearing surfaces of said diaphragm are equipped with roller mechanisms to facilitate the movement of said diaphragm within said fluid storage container.

37. Device according to claim 34, wherein said bearing surfaces are continuous along the circumference of said diaphragm.

38. Device according to claim 34, wherein said bearing surfaces are distributed in a discontinuous manner along the circumference of the diaphragm.

39. Device according to claim 38, wherein the unit area of contact between each bearing surface and said container differs according to the bearing surface.

40. Device according to claim 31, wherein said liquid containing portion is connected to said gas containing portion, on the one hand by a first pipe equipped with a pump which allows bringing liquid in said gas containing portion to said liquid containing portion, and on the other hand by a second pipe equipped with a compressor which allows bringing gas in said liquid containing portion said the gas containing portion.

41. Device according to claim 31, comprising a system for exchanging heat between the gas and a heat transfer fluid, during the compression of the gas in said compression facility and during the expansion of the gas in said expansion facility.

42. Device according to claim 41, wherein said heat exchange system comprises a heat reservoir for storing the heat transfer fluid heated by the gas compression, said heat reservoir being thermally insulated and comprising means for pressurizing the heat transfer fluid.

43. Device according to claim 42, wherein the heat reservoir is located inside said gas containing portion of the fluid storage container, and comprises a plunger interfacing with the gas in said fluid storage container and the heat transfer fluid in said heat reservoir.

44. Device according to claim 42, wherein said heat reservoir is located outside said fluid storage container and comprises a portion supplied with heat transfer fluid and a portion supplied with compressed gas, said two portions being located on each side of a diaphragm arranged in said heat reservoir to ensure fluid tightness between said two portions.

45. Device according to claim 41, wherein the heat transfer fluid is water.

46. Device according to claim 31, wherein said liquid inlet port is combined with the liquid outlet port.

47. Device according to claim 31, wherein said gas inlet port is combined with the gas outlet port.

48. Device according to claim 31, comprising a plurality of fluid storage containers, and comprising a set of valves on said gas inlet and outlet ports and a set of valves on said liquid inlet and outlet ports, which allow selecting containers where the gas is injected and containers where the gas is discharged.

49. Device according to claim 31, wherein the gas is air and the liquid is water.

50. Device according to claim 31, wherein said discharge facility comprises an expansion facility, containing at least one pressure reducer and an electric generator for producing electrical energy by the expansion of the compressed gas.

51. Device according to claim 50, wherein said discharge facility further comprises an industrial facility, connected to said expansion facility in order to use the expanded gas in an industrial process.

52. Device according to claim 50, wherein said discharge facility further comprises an industrial facility, connected to said gas outlet port in order to use the compressed gas in an industrial process.

53. Device according to claim 51, wherein said discharge facility comprises means for bringing the gas to the pressure required by the industrial facility.

54. Device according to claim 31, wherein said discharge means comprise a generator group connected to said liquid outlet port, said generator group comprising a turbine and a generator, the discharged liquid passing through said turbine for the generation of electrical energy by said generator.

55. Device according to claim 20 and claim 24, comprising a system for regulating and controlling said motor group and a system for regulating and controlling said generator group.

56. Method for storing and delivering a compressed gas in a device according to claim 55, comprising the following steps:
a gas storage step, comprising the following operations:
compressing the gas in said compression facility,
injecting the gas into said fluid storage container through said gas inlet port,
simultaneously with injecting the gas, discharging liquid towards said generator group through said liquid outlet port, with said system for regulating and controlling said generator group in order to discharge the liquid maintaining a constant pressure in said fluid storage container,
a gas delivery step, comprising the following operations:
injecting liquid from said source of liquid through said liquid inlet port into said fluid storage container,
simultaneously with injecting the liquid, discharging gas towards said discharge facility, with said system for regulating and controlling said motor group in order to inject the liquid maintaining a constant pressure in said fluid storage container.

57. Method according to claim 26, wherein said storage step and said delivery step take place simultaneously.

58. Method for starting up a device according to claim 56, from a state in which said motor group, said generator group, said compression facility, and said expansion facility are shut down and in which said fluid storage container contains compressed gas and liquid, said method comprising the following steps:
recognizing a request for a level of energy,
starting up said expansion facility and increasing its power to reach the requested level of energy, by discharging the gas from said fluid storage container,
simultaneously with the previous step, starting up said generator group and increasing its power, thereby generating the requested energy by discharging liquid from said fluid storage container, said system for regulating and controlling said generator group controlling the pressure drop in said fluid storage container,
progressively decreasing the power of the generator group as the power of said expansion facility is increased, said generator group being shut down when said expansion facility is producing the requested energy,
after the preceding step, starting up said motor group and increasing its power simultaneously with increasing the power of the expansion facility, said system for regulating and controlling said motor group controlling the increase in pressure in said fluid storage container until the desired pressure is reached,
carrying out the storage and delivery method.

59. Method according to claim 56, wherein said device is in the gas delivery step, said method comprising a transitional step comprising the following operations:
recognizing a request for a level of energy exceeding what is being supplied by said expansion facility,
increasing the power of said expansion facility,
simultaneously with the preceding step, reducing the power of said motor group to allow the device to provide more energy,
if the power of said motor group is reduced until it shuts down and the requested level of energy has not been reached by said device:
turning on said generator group and increasing its power in order to supply the requested level of energy by discharging liquid through said liquid outlet port of said fluid storage container,
when said device reaches the requested level of energy, progressively reducing the power of said generator group as the power from said expansion facility increases,
when said generator group shuts down, turning on said motor group and increasing its power simultaneously with increasing the power of said expansion facility in order to restore a given pressure in said fluid storage container;
otherwise, when said device reaches the requested level of energy, increasing the power of said motor group simultaneously with increasing the power of said expansion facility in order to restore a given pressure in said fluid storage container,
resuming the operations of the delivery step.

60. Method according to claim 56, wherein said device is in the gas storage step, said method comprising a transitional step comprising the following operations:
recognizing a variation in the level of energy supplied to said compression facility,
when the variation is a decrease, increasing the power from said generator group to produce the necessary compensating energy for said compression facility by discharging liquid from said fluid storage container,
when the variation is an increase, increasing the power from said motor group to consume the energy not consumed by said compression facility by injecting liquid into said fluid storage container.
